(19) United States
(12) Patent Application Publication
(10) Pub. No.: US 2025/0083078 A1
(43) Pub. Date: Mar. 13, 2025

(54) FILTER ASSEMBLY AND WATER PURIFIER INCLUDING THE SAME

(71) Applicant: COWAY Co., Ltd., Gongju-si (KR)

(72) Inventors: Hee Dae LEE, Seoul (KR); Ju Hyuk EOM, Seoul (KR); Tae Hun MOON, Seoul (KR); Jong Cheol KIM, Seoul (KR)

(73) Assignee: COWAY Co., Ltd., Gongju-si (KR)

(21) Appl. No.: 18/809,412

(22) Filed: Aug. 20, 2024

(30) Foreign Application Priority Data
Sep. 7, 2023 (KR) 10-2023-0119109
Oct. 5, 2023 (KR) 10-2023-0132369
Oct. 12, 2023 (KR) 10-2023-0135855

(51) Int. Cl. B01D 35/30

(52) U.S. Cl. CPC B01D 35/30; B01D 2201/306

(57) ABSTRACT

A filter assembly includes: a housing; a filter member disposed inside the housing; a water treatment member, disposed inside the housing, for treating the purified water; and a supporter disposed inside the housing to support the filter member and the water treatment member. The supporter includes: a first cap supporting an exterior of the filter member; and a second cap supporting an interior of the filter member and providing an accommodation space in which the water treatment member is accommodated. The second cap includes: a second body having an opening, formed in an upper portion thereof, through which the water treatment member is taken in and out, and a second body hole, formed in a side wall thereof, through which the purified water passes; and a second upper cap arranged to be fixed to the opening and having a second cap hole through which the purified water passes.

### TECHNICAL FIELD

The present disclosure relates to a filter assembly and a water purifier including the same.

### BACKGROUND

In general, a filter is a filtration means installed in a water purifier to remove heavy metals and other harmful substances contained in raw water such as tap water or mineral water, thereby providing purified water containing only substances beneficial to the human body. Types of such filters include hollow fiber membrane filters, nanotrap (NT) filters, and carbon filters for removing various foreign substances and contaminants in raw water.

In this regard, Korean Patent Application Publication No. 10-2008-0101566 entitled “Activated carbon filter assembly” (hereinafter, Patent Document 1) of the present applicant discloses that a fiber activated carbon member is fixed by an inlet cover and an outlet cover, and an activated carbon member is accommodated in a gap space between the fiber activated carbon member and a core portion.

However, since the inlet cover and outlet cover disclosed in Patent Document 1 support upper and lower portions of a first filter and a second filter simultaneously, there is a problem that when only the activated carbon member is to be replaced in the activated carbon filter assembly, the activated carbon member cannot be replaced without removing both the inlet cover and the outlet cover. In addition, since the activated carbon member is provided in the form of a plurality of granules, it is difficult to quickly replace a plurality of activated carbon members in the gap space between the fiber activated carbon member and the core portion when replacement of the activated carbon members is required.

Further, in general, a water purifier is a device that receives water from a water source such as a tap, filters the water into purified water through a filter provided therein, and then provides the purified water to a user. In addition, the purified water may be provided to the user as cold water cooled to a predetermined temperature or lower or hot water heated to a predetermined temperature or higher by a water purifier. Such a water purifier may include a filter, a frame for accommodating the filter, a fastening part that is fastened to the filter accommodated in the frame to discharge water to the filter, and a cover that opens and closes the frame to allow the filter to be accommodated in or removed from the frame.

In this regard, Korean Patent Application Publication No. 10-2016-0117774 entitled “Fluid pipe connection module and water purifier equipped with the same” (hereinafter, Patent Document 2) of the present applicant discloses a water purifier including a water purifier body, a water purification filter accommodated in the water purifier body, and an assembly head that is detachably connected to the water purification filter to discharge water to the water purification filter.

However, Patent Document 2 has a problem that the water purification filter of the water purifier may be separated from the assembly head by the water discharged from the assembly head. In other words, the water purification filter of Patent Document 2 is not provided with a means to prevent the water purification filter from moving when it is pressed in the direction of being moved away from the assembly head by the water pressure of the assembly head inside the water purifier body. In addition, there is a problem that the water purification filter of Patent Document 2 may be separated from the assembly head due to the water pressure of the assembly head, and water leakage may occur between the filter and the assembly head.

In addition, Korean Patent Application Publication No. 10-2022-0049449 entitled “Water purifier” (hereinafter, Patent Document 3) of the present applicant discloses a water purifier including a filter module, a filter housing for accommodating the filter module, a filter fixture engaged with the filter module and providing a flow path for providing raw water to the filter module, a filter cap that opens and closes the upper side of the filter module, and has a seating rib that interferes with the filter module when the filter module is not engaged with the filter fixture.

However, Patent Document 3 has a problem that the filter module of the water purifier may be separated from the filter fixture by raw water discharged from the filter fixture. In other words, although the filter cap of Patent Document 3 has the seating rib that may interfere with the filter module, the filter module and the seating rib are not in close contact with each other due to a gap, so when the filter module is separated from the filter fixture by the water pressure of the filter fixture, water leakage may occur between the filter module and the filter fixture.

In addition, generally, a filtration filter can filter water provided from a water source such as a tap into purified water. The filtration filter may be configured to be accommodated inside a filter receiving portion of the water purifier and to filter raw water. The filtration filter may include a filter medium and a filter housing that accommodates the filter medium. Further, the filter housing includes a first cover part that covers one side of the filter medium, a second cover part that covers the other side of the filter medium, and a filter medium accommodating part coupled to the first cover part and the second cover part and providing a space for accommodating the filter medium.

In this regard, Korean Patent Application Publication No. 10-2011-0128765 entitled “Filter assembly” (hereinafter, Patent Document 4) of the present applicant discloses a filter assembly including a filter member for filtering water, a filter housing for accommodating the filter member, and a housing cap coupled to the filter housing and covering one side the filter member.

However, Patent Document 4 has a problem that when the filter housing and the housing cap are combined, the filter housing and the housing cap are arranged to partially overlap in the radial direction, so the radius or width of the space in which the filter member is accommodated becomes smaller. In other words, an outer surface of the housing cap of Patent Document 4 is disposed inside the filter housing, so the outer diameter of the filter member may be limited to the inner diameter of the housing cap, so the size of the space in which the filter member is accommodated becomes smaller, and the size of the filter decreases, resulting in lower filtration performance.

### SUMMARY

In view of the above, one embodiment of the present disclosure provides a filter assembly in which a filter member and a water treatment member can be replaced through a supporter located on the upper side of a housing.

Further, one embodiment of the present disclosure provides a filtration filter in which the size of the filter medium can be increased and filtration performance can be increased by forming a larger space in which the filter medium can be accommodated.

In addition, one embodiment of the present disclosure provides a filtration filter that can prevent the filter from being separated from a fastening part due to water pressure and a water purifier including the same.

In accordance with a first aspect of the present application, there is provided a filter assembly including: a housing; a filter member, disposed inside the housing, for filtering raw water to provide purified water; a water treatment member, disposed inside the housing, for treating the purified water; and a supporter disposed inside the housing to support the filter member and the water treatment member, wherein the supporter includes: a first cap supporting an exterior of the filter member; and a second cap supporting an interior of the filter member and providing an accommodation space in which the water treatment member is accommodated, and wherein the second cap includes: a second body having an opening, formed in an upper portion thereof, through which the water treatment member is taken in and out, and a second body hole, formed in a side wall thereof, through which the purified water passes; and a second upper cap arranged to be fixed to the opening and having a second cap hole through which the purified water passes.

The first cap may include: a first body supporting an outer diameter surface of the filter member, and having a first body hole through which the raw water passes; a first upper cap supporting an upper end portion of the filter member and having a first cap hole corresponding to the second cap hole; and a first lower cap supporting a lower end portion of the filter member.

The first body, the first upper cap, and the first lower cap may be formed to have the same thickness and outer diameter.

The second upper cap may be spaced apart from an upper end of the second body to form a space between the second cap hole and the first cap hole. The water treatment member may be formed with an outer diameter that is at least larger than an inner diameter of the second body hole and an inner diameter of the second cap hole.

The second upper cap may include: a second cap portion having a through-hole in a center thereof; and a second mesh portion fixed to the second cap portion to be located in the through-hole, the second cap hole being provided in the form of a mesh in the second mesh portion.

The second upper cap may be fixed to the second body through ultrasonic fusion.

The water treatment member may include: a water treatment pouch that provides a pouch space therein and is made of a flexible material; and a plurality of water treatment particles accommodated in the pouch space.

The first cap may include: a first upper cap covering one surface of the filter member; a first lower cap covering the other surface of the filter member; and a first body provided between the one surface and the other surface of the filter member to cover a peripheral surface of the filter member, the first upper cap and the first lower cap may be arranged to be spaced apart from each other by a distance equal to or greater than a length of the first body, an end of the first upper cap may be disposed to face one end of the first body, an end of the first lower cap may be disposed to face the other end of the first body, and the first body may have a shape spaced apart from at least one of the first upper cap and the first lower cap.

The first upper cap may include: a first end cover part in contact with the one surface of the filter member; and a first extension part extending from an edge of the first end cover part toward the first lower cap and covering a portion of the peripheral surface of the filter member, and the first lower cap may include: a second end cover part in contact with the other surface of the filter member; and a second extension portion extending from an edge of the second end cover portion toward the first upper cap and covering another portion of the peripheral surface of the filter member.

At least one of an inner diameter of the first upper cap and an inner diameter of the first lower cap may be smaller than an outer diameter of the first body.

The first upper cap may be disposed to face one end of the first body but not overlap the first body, and the first lower cap may be disposed to face the other end of the first body but not overlap the first body.

The filter assembly may further include: a filter head protruding upward from an upper portion of the housing; and a filter mouth extending in one direction from one side of the filter head, a stepped portion may be formed on the other side of the filter head, and the stepped portion may include: a first step surface extending downward from a top surface of the filter head; and a second step surface extending in the other direction from the first step surface and connected to the other side of the filter head.

At least a portion of the first step surface may have a shape corresponding to a surface of the other side of the filter head when the housing is viewed from above.

At least a portion of the first step surface may have the same radius of curvature as the surface of the other side of the filter head when the housing is viewed from above.

A front end of the filter mouth may be disposed inside an edge of the housing when viewing the housing from directly above.

The filter assembly may further include: a plurality of filter ribs that protrude forward from a front side of the filter head and are spaced apart from each other along a peripheral surface of the filter mouth. One of the plurality of filter ribs may extend in an up-down direction to be connected to the filter mouth and the upper portion of the housing.

In accordance with a second aspect of the present disclosure, there is provided a filter assembly including: a housing; a filter member for filtering raw water to provide purified water; a water treatment member for treating the purified water; and a supporter disposed inside the housing to support the filter member and the water treatment member, wherein the supporter includes: a first cap supporting an exterior of the filter member; and a second cap supporting an interior of the filter member and providing an accommodation space in which the water treatment member is accommodated, and wherein the water treatment member includes: a water treatment pouch that provides a pouch space therein and is made of a flexible material; and a plurality of water treatment particles accommodated in the pouch space.

The water treatment pouch may be provided in different colors depending on types of water treatment particles so that the types of water treatment particles are distinguished by color.

In accordance with a second aspect of the present disclosure, there is provided a water purifier including: the filter assembly described above; and a frame for accommodating the filter assembly, wherein the frame includes: a filter support frame that provides an accommodation space for accommodating the filter assembly; and a cover frame part configured to be in an open state that opens an upper end of the accommodation space of the filter support frame or in a closed state that closes the upper end of the accommodation space, wherein the cover frame part includes a fixing rib extending downward from a lower surface of the cover frame part to fix the filter assembly accommodated in the accommodation space when the cover frame part is in the closed state, and wherein the fixing rib contacts a stepped portion of the filter assembly when the cover frame part is in the closed state.

According to one aspect of the present disclosure, the filter can be accommodated through the supporter located on the upper side of the housing, so the water treatment member containing water treatment particles can be conveniently and easily replaced through the supporter.

Further, since the first body, first upper cap, and first lower cap constituting the first cap are formed with the same thickness and outer diameter, it is possible to prevent in advance the decrease in the diameter of the filter and the decrease in the membrane area that occurs when the thickness and outer diameter of the first body, first upper cap, and first lower cap are different from each other.

In addition, a plurality of water treatment particles are accommodated in the pouch space of the water treatment pouch made of a flexible material, which makes weight control and management of the plurality of water treatment particles convenient.

Further, by varying the color of the water treatment pouch depending on the type of water treatment particle, the user can easily distinguish the type of water treatment particle through the color of the water treatment pouch.

In addition, according to another aspect of the present disclosure, the first cap member, the second cap member, and the peripheral cover member are spaced apart to form a large space in which the filter media can be accommodated, so that the size of the filter medium can be increased and the filtration performance can be increased.

Further, according to still another aspect of the present disclosure, since the filtration filter is formed with the stepped portion for contacting the fixing rib of the water purifier, the filtration filter can be prevented from moving backward in the water purifier due to water pressure.

In addition, one of the plurality of filters formed in different sizes has the stepped portion formed thereon, so that it can be replaced with another one of the plurality of filters mounted inside the water purifier, thereby improving compatibility.

### BRIEF DESCRIPTION OF THE DRAWINGS

FIG. 1 is a perspective view of a filter assembly according to a first embodiment of the present disclosure.

FIG. 2 is a cross-sectional view of the filter assembly of FIG. 1 taken along line II-II.

FIG. 3 is an exploded perspective view of the filter assembly of FIG. 1.

FIG. 4 is an enlarged perspective view of a supporter and a filter of FIG. 3.

FIG. 5 is a cross-sectional view of the filter assembly of FIG. 4 taken along line V-V.

FIG. 6 is an exploded perspective view of the supporter and the filter of FIG. 4.

FIG. 7 is an enlarged perspective view of a second cap of FIG. 6.

FIG. 8 is a longitudinal cross-sectional perspective view of the second cap of FIG. 6.

FIG. 9 is a longitudinal cross-sectional perspective view of the second cap of FIG. 6, according to a modified example of the first embodiment of the present disclosure.

FIG. 10 is a perspective view of a water purifier according to a second embodiment of the present disclosure.

FIG. 11 is a perspective view of the water purifier according to the second embodiment of the present disclosure, with a cover frame part of the water purifier open.

FIG. 12 is a cross-section of the water purifier of FIG. 10 taken along line XII-XII.

FIG. 13 is a cross-sectional view of the cover frame part of the water purifier of FIG. 11 in an open state.

FIG. 14 is a perspective view of one side of the cover frame part of the water purifier according to the second embodiment of the present disclosure.

FIG. 15 is a perspective view of the other side of the cover frame part of the water purifier according to the second embodiment of the present disclosure.

FIG. 16 is an enlarged view of part B of FIG. 12.

FIG. 17 is a perspective view of one side of a first filter assembly of the water purifier according to the second embodiment of the present disclosure.

FIG. 18 is a side view of the first filter assembly of the water purifier according to the second embodiment of the present disclosure.

FIG. 19 is a perspective view of the other side of the first filter assembly of the water purifier according to the second embodiment of the present disclosure.

FIG. 20 is a cross-sectional view of a second filter assembly according to the second embodiment of the present disclosure disposed inside the water purifier.

FIG. 21 is an enlarged view of part C of FIG. 20.

### DETAILED DESCRIPTION

Hereinafter, specific embodiments for implementing the technical ideas of the present disclosure will be described in detail with reference to the drawings.

In addition, in describing the present disclosure, when it is determined that a detailed description of the relevant known configuration or function may obscure the main idea of the present disclosure, the detailed description thereof will be omitted.

Further, when a component is mentioned to be “connected” or “flowing” to another component, it should be understood that it may be directly connected to or flowing to another component, but there may be other components therebetween.

The terms used in the present specification are used merely to describe the specific embodiments and are not intended to limit the present disclosure. Singular expressions include the plural unless the context clearly indicates otherwise.

Further, in the present specification, it should be noted that expressions such as upper, lower, side, and the like are described with reference to the drawings and may be expressed differently when the orientation of the subject matter is changed. Similarly, in the accompanying drawings, some components are exaggerated, omitted, or shown schematically, and the dimensions of each component do not necessarily reflect actual dimensions.

Furthermore, the terms containing ordinal numbers, such as first, second, etc., may be used to describe various components, but the components are not limited by such terms. These terms are used only to distinguish one component from another.

The meaning of “include” used in the present specification is intended to specify certain features, areas, integers, steps, operations, elements, and/or components, and is not intended to exclude the existence or the addition of other specific features, areas, integers, steps, operations, elements, components, and/or groups.

Hereinafter, a filter assembly 10 according to one embodiment of the present disclosure will be described with reference to the drawings.

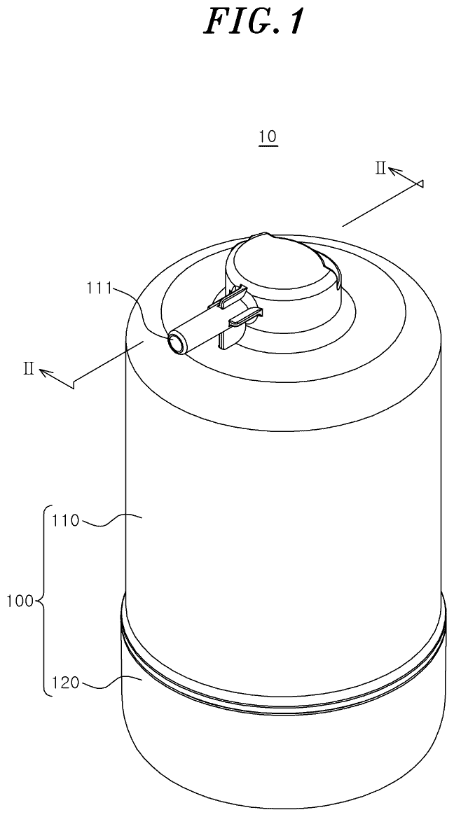

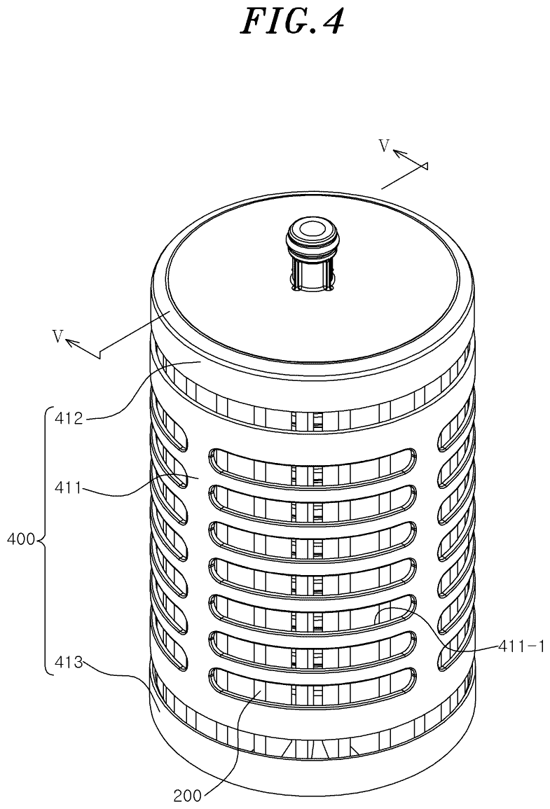

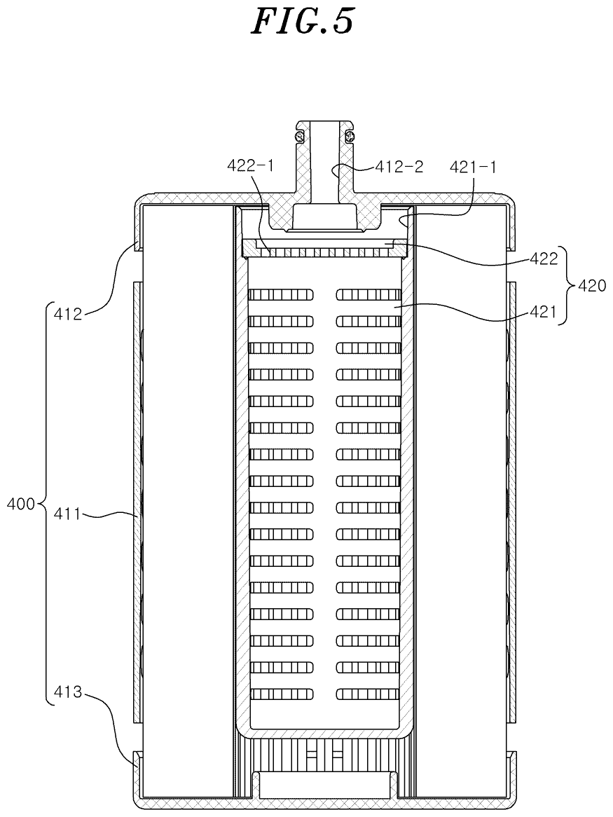

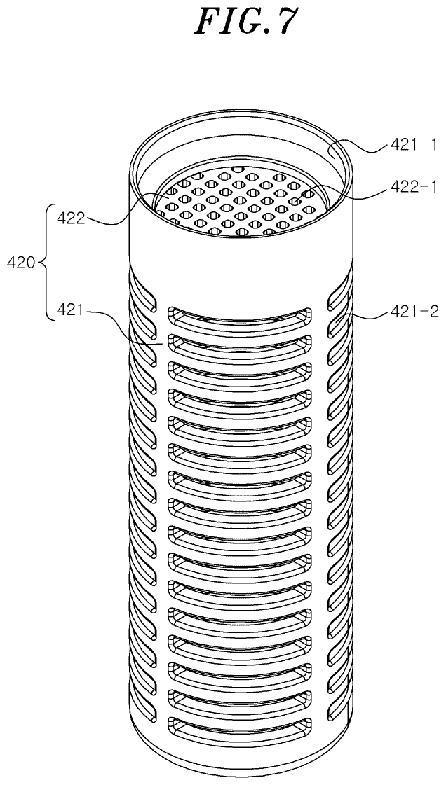

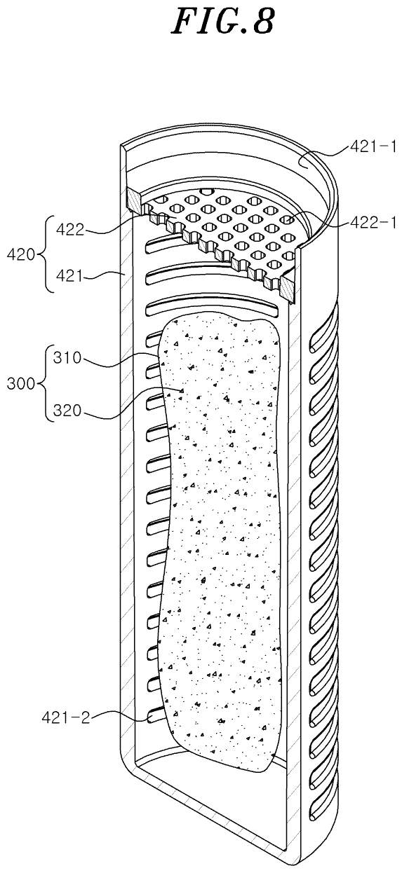

Referring to FIGS. 1 to 8, the filter assembly 10 according to one embodiment of the present disclosure can provide clean water to users by filtering and treating water supplied from outside. Prior to a detailed description, water flowing into the filter assembly 10 from the outside may be categorized into raw water and purified water. Hereinafter, among the water that flows into the filter assembly 10 from the outside, water that has not passed through a filter is defined as raw water, and water that has been filtered through the filter is defined as purified water. The filter assembly 10 may include a housing 100, a filter member 200, a water treatment member 300, and a supporter 400.

The housing 100 may accommodate the filter member 200, the water treatment member 300, and the supporter 400. The housing 100 may include an upper housing member 110 and a lower housing member 120.

The upper housing member 110 may provide a space in which the filter member 200, the water treatment member 300, and the supporter 400 can be accommodated. The upper housing member 110 may be formed in a cylindrical shape with an open bottom, but is not limited thereto. The upper housing member 110 may be formed to have a larger width than the supporter 400. For example, an inner diameter of the upper housing member 110 may be formed to be at least larger than an outer diameter of the supporter 400. A height of the upper housing member 110 in an up-down direction may be greater than a height of the supporter 400 in the up-down direction. The upper housing member 110 may be formed with an inlet 111 through which raw water flows in and an outlet 112 through which purified water is discharged to the outside. For example, the inlet 111 and the outlet 112 may be formed on an upper portion of the upper housing member 110. The inlet 111 may communicate with a water inlet flow path of the water purifier, and the outlet 112 may communicate with a water outlet flow path of the water purifier.

The lower housing member 120 may be coupled to a lower portion of the upper housing member 110. For example, the lower portion of the upper housing member 110 may be fitted and coupled to an upper portion of the lower housing member 120. The upper portion of the lower housing member 120 may be coupled to at least overlap the lower part of the upper housing member 110. An upper inner diameter of the lower housing member 120 may be at least larger than a lower outer diameter of the upper housing member 110.

The filter member 200 can filter raw water. Raw water may flow into the filter member 200 through the inlet 111 of the housing 100. The filter member 200 may be accommodated in an outer side of an internal space of the housing 100. The filter member 200 may be supported by the supporter 400 and disposed outside the water treatment member 300. As an example, the filter member 200 may have a ring shape, and the filter member 200 may include a carbon filter or a nanotrap (NT) filter.

The water treatment member 300 can treat purified water filtered by the filter member 200. The treated purified water may be discharged through the outlet 112 of the housing 100. In this case, water treatment may encompass the concept of adjusting the quality of purified water to suit a predetermined purpose or providing a specific function to purified water. For example, the water treatment member 300 may filter purified water, remove scale, change purified water into soft water by removing hardness components from the purified water, or provide minerals needed by a user to the purified water. The water treatment member 300 may be disposed inside the filter member 200. The water treatment member 300 may be accommodated inside the housing 100 or may be removed from the housing 100 through a second cap 420, which will be described later.

The water treatment member 300 may be provided in the form of a pouch. The water treatment member 300 may have an outer diameter that is at least larger than an inner diameter of a second body hole 421-2 and an inner diameter of a second cap hole 422-1 of the second cap 420. The water treatment member 300 may include a water treatment pouch 310 and water treatment particles 320.

The water treatment pouch 310 may be a pouch that provides a pouch space inside. The water treatment pouch 310 may be made of a flexible material. As an example, the water treatment pouch 310 may be made of a non-woven material. The water treatment particles 320 may be accommodated in the pouch space of the water treatment pouch 310. The water treatment pouch 310 may be provided in different colors to distinguish the types of water treatment particles 320. If the color of the water treatment pouch 310 is matched in advance according to the type of water treatment particles 320, the user can distinguish the type of water treatment particles 320 accommodated in the pouch space of the water treatment pouch 310 through the color of the water treatment pouch 310, even without opening the water treatment pouch 310.

The water treatment particles 320 may be a functional material capable of treating purified water filtered by the filter member 200. As an example, the water treatment particles 320 may be a functional material such as polyphosphate particles. Polyphosphate particles can be dissolved in purified water to remove scale. In the present embodiment, the water treatment particles 320 are described as polyphosphate particles, but are not limited thereto, and the water treatment particles 320 may be various types of particles such as ferric, manganese, and descale particles in addition to polyphosphate particles.

The supporter 400 may be disposed inside the housing 100 to support the filter member 200 and the water treatment member 300. The supporter 400 may guide the flow of raw water and purified water within the housing 100 so that the raw water and purified water flow toward the filter member 200, the water treatment member 300, and the outlet 112. A flow path for raw water to flow may be formed between an outer peripheral surface of the supporter 400 and an inner peripheral surface of the housing 100. The flow path may be a passage for guiding raw water introduced in the housing 100 through the inlet 111 to the filter member 200. The supporter 400 may include a first cap 410 and a second cap 420.

The first cap 410 may support an outer surface of the filter member 200. The first cap 410 may be placed inside the housing 100 and outside the second cap 420. The first cap 410 may include a first body 411, a first upper cap 412, and a first lower cap 413.

The first body 411 may support an outer diameter surface portion of the filter member 200 to surround it. A first body hole 411-1 through which raw water can pass may be formed in the first body 411. As an example, the first body hole 411-1 may be in the form of a slit extending in a circumferential direction of the first body 411. A plurality of first body holes 411-1 may be provided to be spaced apart in the circumferential direction and a height direction of the first body 411.

The first upper cap 412 may support upper end portions of the filter member 200 and the second cap 420. The first upper cap 412 may be arranged to be spaced apart from an upper end of the first body 411. Raw water may pass through the space between the first upper cap 412 and the first body 411. A first cap hole 412-2 corresponding to the second cap hole 422-1 of the second cap 420 may be formed in the first upper cap 412. The first cap hole 412-2 may guide purified water discharged from the second cap hole 422-1 to the outlet 112. The first cap hole 412-2 may be connected in communication with the outlet 112 of the housing 100.

The first lower cap 413 may support a lower end portion of the filter member 200. The first lower cap 413 may be arranged to be spaced apart from a lower end of the first body 411. Raw water may pass through the space between the first lower cap 413 and the first body 411. These first body 411, first upper cap 412, and first lower cap 413 may be formed to have the same thickness, inner diameter, and outer diameter.

The second cap 420 may support the inner surface of the filter member 200. The second cap 420 may be placed inside the housing 100 and may be placed on the inner diameter side of the filter member 200. The second cap 420 may include a second body 421 and a second upper cap 422.

The second body 421 may support an inner diameter surface of the filter member 200. An accommodation space in which the water treatment member 300 can be accommodated may be formed inside the second cap 420. An opening 421-1 through which the water treatment member 300 can be taken in and out may be formed in an upper portion of the second body 421. The opening 421-1 may be formed with an inner diameter that is at least larger than an outer diameter of the water treatment member 300. A second body hole 421-2 may be formed on a sidewall of the second body 421. Purified water that has passed through the water treatment member 300 may pass through the second body hole 421-2. For example, the second body hole 421-2 may be in the form of a slit extending in a circumferential direction of the second body 421. A plurality of second body holes 421-2 may be provided to be spaced apart in the circumferential direction and a height direction of the second body 421.

The second upper cap 422 may be a cap disposed on the upper portion of the second body 421. The second upper cap 422 may be fixed to the opening 421-1 of the second body 421. In the present embodiment, the second upper cap 422 is fixed to the opening 421-1 of the second body 421 through ultrasonic fusion, but the present disclosure is not limited thereto, and the second upper cap 422 may be detachably fixed to the opening 421-1 of the second body 421 for addition and replacement of the water treatment member 300. When the second upper cap 422 is disposed on the upper portion of the second body 421, the second upper cap 422 may be disposed to be spaced apart from an upper end of the second body 421 to form a space between the second cap hole 422-1 and the first cap hole 412-2. The second cap hole 422-1 through which purified water passes may be formed in the second upper cap 422. A plurality of second cap holes 422-1 may be provided penetrating the second upper cap 422.

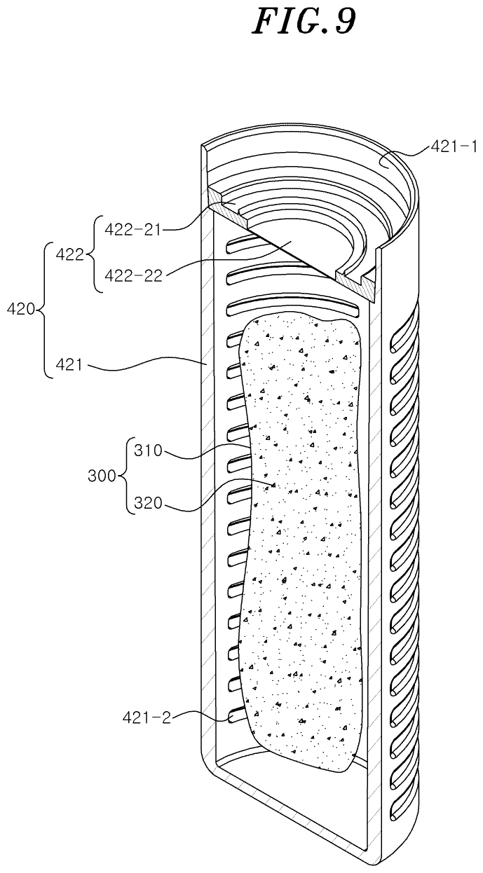

Referring to FIG. 9, according to a modified example of the present disclosure, the second upper cap 422 may use a mesh net to prevent discharge of the water treatment member 300 while guiding purified water that has passed through the water treatment member 300 to the outlet 112 of the housing 100. The second upper cap 422 may include a second cap portion 422-21 and a second mesh portion 422-22.

The second cap portion 422-21 may be disposed on the upper portion of the second body 421. The second cap portion 422-21 may be seated on a locking protrusion formed on the upper portion of the second body 421. The second cap portion 422-21 may be formed to have an outer diameter corresponding to an upper inner diameter of the second body 421. When the second cap portion 422-21 is disposed on the upper portion of the second body 421, the second cap portion 422-21 is disposed to be spaced apart from the upper end of the second body 421, so a space may be formed between the second cap portion 422-21 and the first cap hole 412-2. A through-hole may be formed in the center of the second cap portion 422-21.

The second mesh portion 422-22 may be fixed to the through-hole of the second cap portion 422-21. An edge portion of the second mesh portion 422-22 may be coupled to the through-hole of the second cap portion 422-21. The second mesh portion 422-22 may be provided in the form of a mesh in the second cap hole 422-1. For example, the second mesh portion 422-22 may be a mesh net.

Hereinafter, the first cap 410 of the filter assembly 10 and its surrounding configuration according to one embodiment of the present disclosure will be described with reference to the drawings.

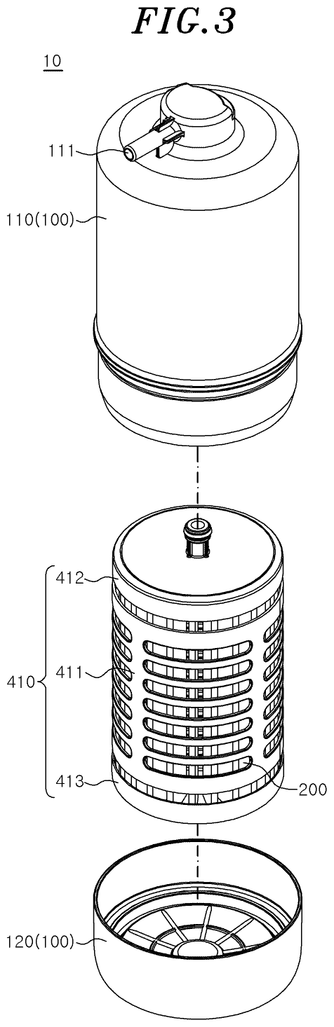

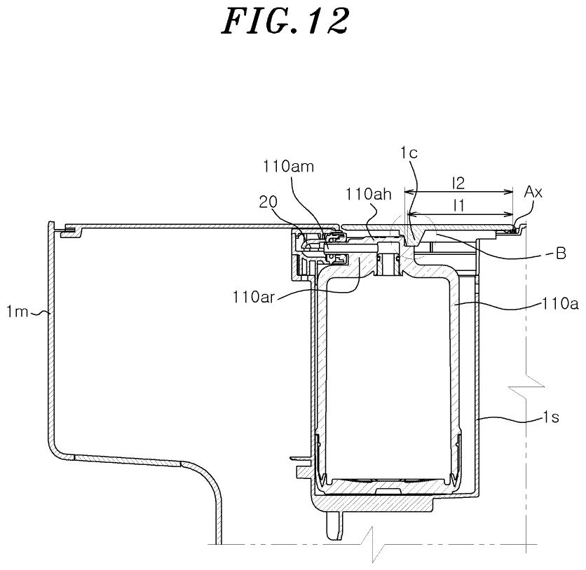

Referring to FIGS. 3 and 12, the filter assembly 10 according to one embodiment of the present disclosure may be disposed inside the water purifier 1 to filter the water flowing into the water purifier 1 to provide clean water to the user. In other words, the filter assembly 10 may be accommodated in an inner space of a filter support frame 1s of the water purifier 1. The filter support frame 1s may provide a space to accommodate the filter assembly 10. For example, the filter assembly 10 may be inserted into the filter support frame 1s in an up-down direction. The inner surface of the filter support frame 1s may be formed in a shape corresponding to the outer surface of the filter assembly 10. The filter assembly 10 may include a filter member 200, a first cap 410, and a filter housing 100.

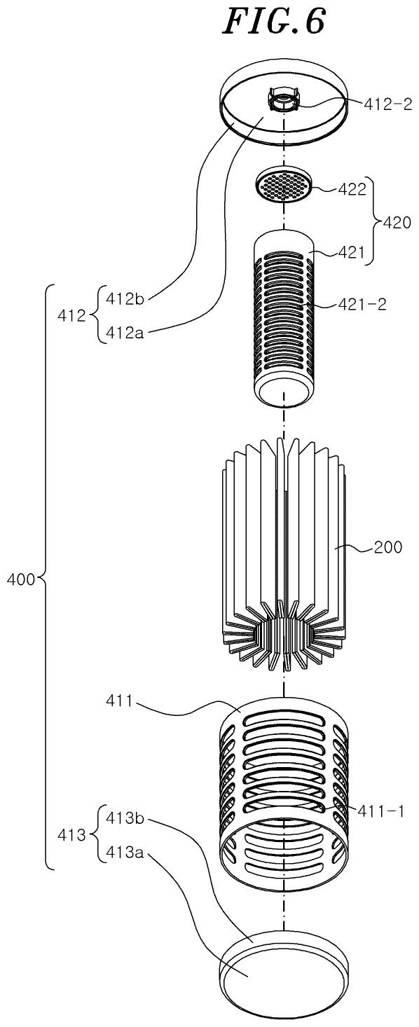

Referring further to FIG. 6, the filter member 200 may filter water. The filter member 200 may be accommodated in the first cap 410. The filter member 200 may extend along the inner surface of the first cap 410. In addition, a peripheral surface of the filter member 200 extending along the inner surface of the first cap 410 may be bent so that a plurality of peaks and a plurality of valleys are alternately arranged.

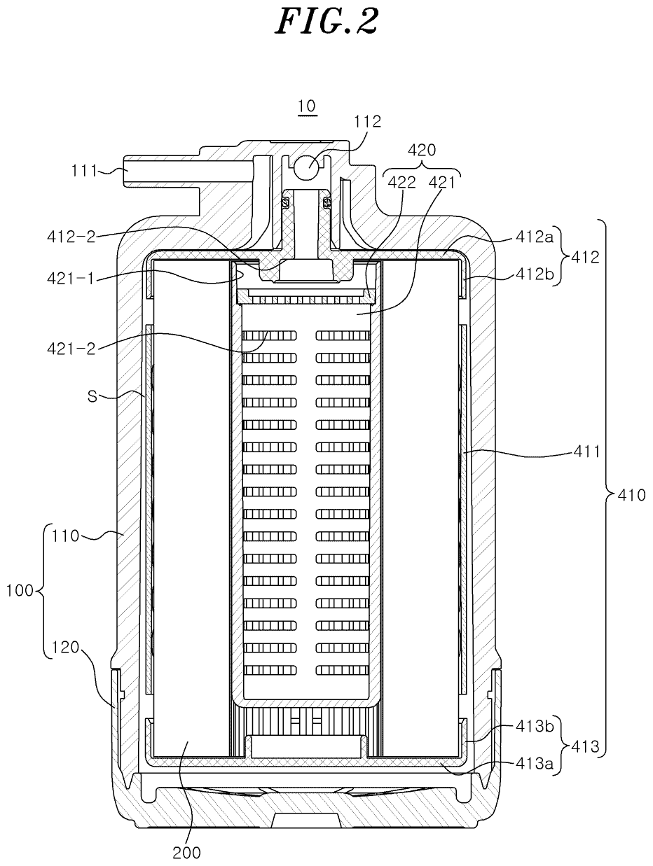

Referring further to FIG. 2, the first upper cap 412 may cover one side of the filter member 200 (the upper part of the filter member in FIG. 2). An end of the first upper cap 412 may be disposed outside the circumferential surface of the filter member 200 to face one end of the first body 411. In addition, the first upper cap 412 may be disposed to face one end of the first body 411 but not overlap the first body 411 in a radial or width direction. In other words, the first upper cap 412 may be arranged to be spaced apart from the first body 411 without being connected to it.

An inner diameter of the first upper cap 412 may be smaller than the outer diameter of the first body 411. In additionally, the outer diameter of the first upper cap 412 may be the same as the outer diameter of the first lower cap 413 and the outer diameter of the first body 411. The first upper cap 412 may include a first end cover portion 412a and a first extension portion 412b.

The first end cover portion 412a may be in contact with one side of the filter member 200. The first end cover portion 412a may be adhered to the filter member 200 using a separate adhesive, but is not limited thereto. In addition, the first end cover portion 412a may support the first extension portion 412b.

The first extension portion 412b may extend from an edge of the first end cover portion 412a toward the first lower cap 413. The first extension portion 412b may extend to cover a portion of the peripheral surface of the filter member 200. In other words, the first extension portion 412b may be in contact with the peripheral surface of the filter member 200. An end of the first extension portion 412b may be disposed to face one end of the first body 411. In addition, an outer diameter of the first extension portion 412b may be the same as the outer diameter of the first body 411.

The first lower cap 413 may cover the other side of the filter member 200 (the lower part of the filter member in FIG. 2). The end of the first lower cap 413 may be disposed outside the peripheral surface of the filter member 200 to face the other end of the first body 411. Further, the first lower cap 413 may be disposed to face the other end of the first body 411, but not overlap the first body 411 in the radial or width direction. In other words, the first lower cap 413 may be arranged to be spaced apart from the first body 411 without being connected to it.

The first upper cap 412 and the first lower cap 413 may be arranged to be spaced apart from each other by a distance greater than a length of the first body 411. An inner diameter of the first lower cap 413 may be smaller than the outer diameter of the first body 411. The first lower cap 413 may include a second end cover portion 413a and a second extension portion 413b.

The second end cover portion 413a may be in contact with the other side of the filter member 200. The second end cover portion 413a may be adhered to the filter member 200 using a separate adhesive, but is not limited thereto. In addition, the second end cover portion 413a may support the second extension portion 413b.

The second extension portion 413b may extend from an edge of the second end cover portion 413a toward the first upper cap 412. The second extension portion 413b may extend to cover another portion of the peripheral surface of the filter member 200. In other words, the second extension portion 413b may be in contact with the peripheral surface of the filter member 200. An end of the second extension 413b may be disposed to face the other end of the first body 411. In addition, an outer diameter of the second extension portion 413b may be the same as the outer diameter of the first body 411.

The first body 411 may extend along the peripheral surface of the filter member 200 to cover at least a portion of the peripheral surface of the filter member 200. For example, a portion of the filter member 200 may be inserted into the first body 411. The first body 411 may be disposed between the first upper cap 412 and the first lower cap 413 and have a shape spaced apart from at least one of the first upper cap 412 and the first lower cap 413. In addition, the first body 411 may extend longer than the first extension portion 412b and the second extension portion 413b, but may be formed to be smaller than the filter member 200.

The filter housing 100 may provide a space to accommodate the filter member 200 and the first cap 410. The filter housing 100 may provide the appearance of the filter assembly 10. In addition, an outer surface of the filter housing 100 may be formed to correspond to the inner surface of the filter support frame 1s of the water purifier 2. The filter housing 100 may be configured to allow water to flow in from the outside and to discharge water filtered by the filter member 200. In addition, the filter housing 100 may be configured to form a gap with the first cap 410 and may be provided in a flow path space S through which water flowing into the filter housing 100 may flow. The flow path space S may guide water to the filter member 200. In other words, water flowing into the filter housing 100 may flow to the filter member 200 through the flow path space S to be filtered, and then be discharged to the outside.

Hereinafter, a water purifier 1 according to a second embodiment of the present disclosure will be described with reference to the drawings.

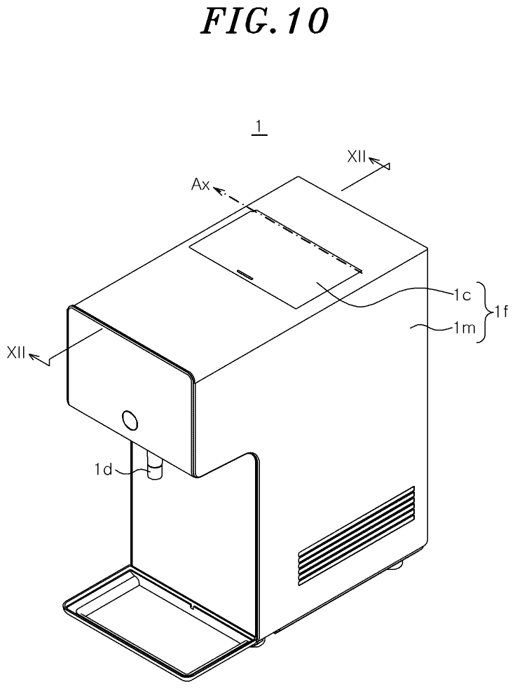

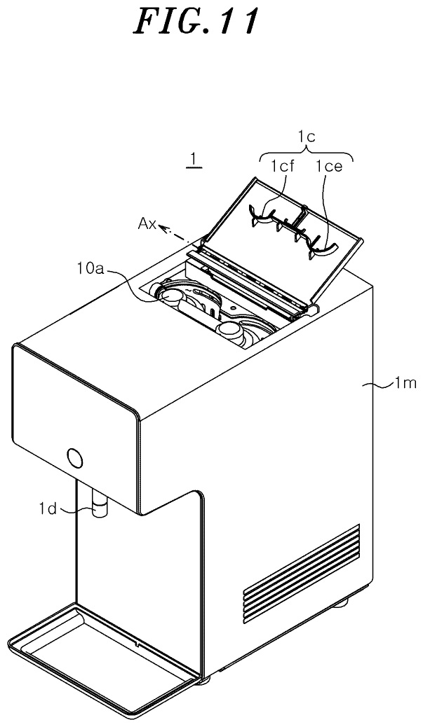

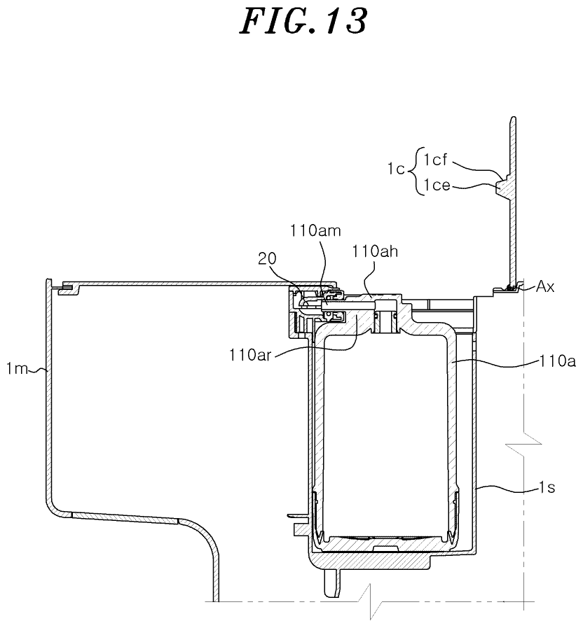

Referring to FIGS. 10 to 13, the water purifier 1 according to the second embodiment of the present disclosure can provide clean water to the user by filtering water supplied from the outside. The water purifier 1 may include a frame 1f, a fastening part 20, a filter assembly 10, and a discharge part 1d.

Water flowing into the water purifier 1 from the outside can be divided into raw water and purified water. Hereinafter, raw water is defined as water that flows into the water purifier 1 from the outside and does not pass through the filter assembly 10, and purified water is defined as water that has been filtered through the filter assembly 10.

The frame 1f may support the filter assembly 10 and the fastening part 20. In addition, the frame 1f may provide an accommodation space for accommodating the filter assembly 10 and the fastening part 20. The frame 1f may include a main frame part 1m, a cover frame part 1c, and a filter support frame 1s.

The main frame part 1m may support the fastening part 20 and the filter assembly 10, and may provide the accommodation space for accommodating the fastening part 20 and the filter assembly 10. The main frame part 1m may be a housing that forms the exterior of the water purifier 1. In addition, a discharge part 1d that discharges filtered water may be disposed on one side of the main frame part 1m. The one side may be the front side of the main frame part 1m, and the other side opposite to the one side may be the rear side of the main frame part 1m.

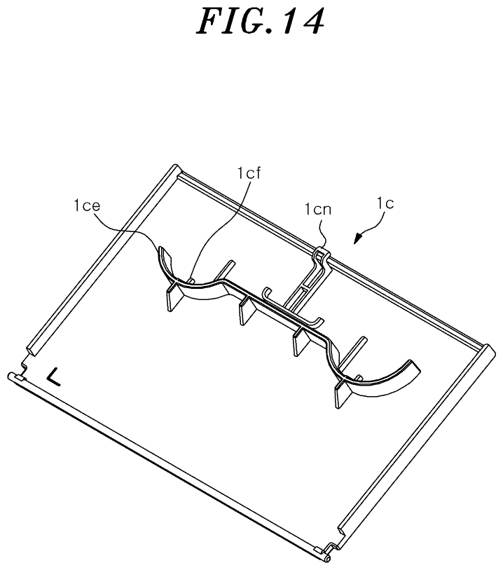

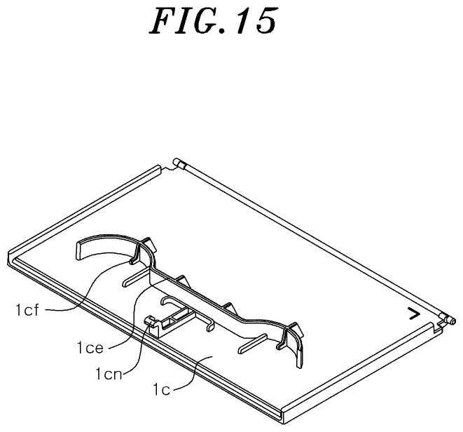

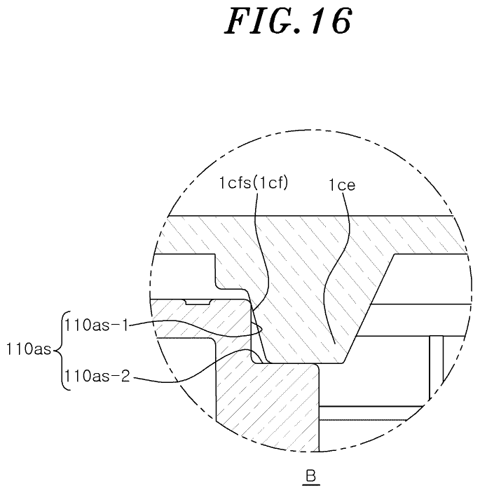

Referring further to FIGS. 14 to 16, the cover frame part 1c may be coupled to the main frame part 1m to open and close the top of the accommodation space of the main frame part 1m. In other words, the cover frame part 1c may be placed in an open state that opens the top of the accommodation space of the main frame part 1m or a closed state that closes the top of the accommodation space. In addition, the cover frame part 1c may be rotatably coupled to the main frame part 1m about a rotation axis Ax extending in a left-right direction to be switched between the open state and the closed state. For example, the cover frame part 1c may be hingedly coupled to the main frame part 1m at its rear end to be rotatable. The cover frame part 1c may be switched to the open state when rotated upwardly from the closed state, and may be switched to the closed state when rotated downwardly from the open state. In addition, the cover frame part 1c may be pressed downward toward the main frame part 1m to be switched from the closed state to the open state by an engaging portion 1cn, which will be described later. For example, the front side of the cover frame part 1c may be pressed by the user to change from the closed state to the open state. In other words, the cover frame part 1c may be rotated downward in the closed state and then rotated upward to be switched to the open state. When the cover frame part 1c in the closed state, the fastened state of the filter assembly 10 may be maintained. The cover frame part 1c may include a fixing rib 1cf, an extension rib 1ce, and an engaging portion 1cn.

When the cover frame part 1c is in the closed state, the fixing rib 1cf extends downward from a lower surface of the cover frame part 1c and is connected to a front surface of the extension rib 1ce to protrude forward from the front surface of the extension rib 1ce. Further, the fixing rib 1cf may include an inclined surface 1cfs that extends downwardly from the lower surface of the cover frame part 1c and is inclined backwardly when the cover frame part 1c is in the closed state. In other words, when the cover frame part 1c is in the closed state, a distance 11 in a front-rear direction between the bottom of the inclined surface 1cfs and the rotation axis Ax may be shorter than a distance 12 in the front-rear direction between the top of the inclined surface 1cfs and the rotation axis Ax.

The inclined surface 1cfs can prevent the filter assembly 10 from being separated from the fastening part 20 by the water pressure of raw water discharged from the fastening part 20 or the water pressure of purified water discharged from the filter assembly 10. In other words, the inclined surface 1cfs can contact the filter assembly 10 and prevent the filter assembly 10 from moving backward when the filter assembly 10 is moved backward by water pressure in a fully fastened state. The fully fastened state may mean a state in which the filter assembly 10 is fastened to the fastening part 20 so that the filter assembly 10 is spaced apart from the inclined surface 1cfs when the cover frame part 1c is closed, or a state in which the filter assembly 10 is fastened to the fastening part 20 so that the filter assembly 10 cannot be further moved forward.

In a state that the inclined surface 1cfs is in close contact with the filter assembly 10 by water pressure, when the cover frame part 1c is pressed downward, the inclined surface 1cfs can move the filter assembly 10 forward. In addition, the inclined surface 1cfs may be spaced apart from the filter assembly 10 moved forward when the pressing against the cover frame part 1c is released. In other words, the inclined surface 1cfs pushes the filter assembly 10 forward when the cover frame part 1c is pressed downward to further insert a filter mouth, which will be described later, into the fastening part 20, and then when the pressing against the cover frame part 1c is released and the cover frame part 1c is rotated upward, the close contact between the inclined surface 1cfs and the filter assembly 10 can be eliminated. In addition, since the close contact between the inclined surface 1cfs and the filter assembly 10 can be eliminated, the cover frame part 1c can be easily switched to the open state.

The inclined surface 1cfs may press the filter assembly 10 toward the fastening part 20 when it contacts the rear side of the filter assembly 10 while the cover frame part 1c is switched from the open state to the closed state. In other words, the inclined surface 1cfs may contact an upper part of the filter assembly 10 and move the filter assembly 10 forward when the cover frame part 1c is switched from the open state to the closed state in the state that the filter assembly 10 is loosely fastened to the fastening part 20. When the cover frame part 1c is switched to the closed state, the filter assembly 10 in the loosely fastened state may be positioned in a position that is in contact with the inclined surface 1cfs but not in contact with the extension rib 1ce. In addition, because the filter assembly 10 can be moved forward by the inclined surface 1cfs, a filter mouth of the filter assembly 10 can be further inserted into the fastening part 20.

In order to minimize the contact area with the filter assembly 10, the inclined surface 1cfs may be formed to have a predetermined curvature when viewed in the inclined direction, and a thickness in the left-right direction that is smaller than its length extending rearward. In other words, the inclined surface 1cfs may have a convex shape toward the filter assembly 10 when the filter support frame 1s is in the closed state. The inclined surface 1cfs may be in line contact with the filter assembly 10 when the cover frame part 1c is in close contact with the filter assembly 10 in the closed state. In addition, when the inclined surface 1cfs and the filter assembly 10 are in close contact, the contact area between them can be minimized by the line contact, so the cover frame part 1c can be easily switched to the open state, and damage to the filter assembly 10 can be minimized.

The extension rib 1ce may protrude downward from the lower surface of the cover frame 1c and extend in the left and right directions to surround at least a portion of the upper part of the filter assembly 10 when the cover frame 1c is in the closed state. In addition, the extension rib 1ce may be disposed rearward than the filter mouth of the filter assembly 10 when the cover frame part 1c is in the closed state. The extension rib 1ce may interfere with the filter assembly 1c when the cover frame part 1c is switched from the open state to the closed state while the filter assembly 10 is removed from the fastening part 20 inside the filter support frame 1s. When the extension rib 1ce interferes with the filter assembly 10, the cover frame part 1c cannot be switched to the closed state.

Further, when the fixing rib 1cf is damaged or changed, the extension rib 1ce may prevent the filter assembly 10 from moving backward in place of the fixing rib 1cf. In other words, the extension rib 1ce may be in surface contact with the filter assembly 10 to prevent the filter assembly 10 from being separated from the fastening part 20 by water pressure in the event that the fixing rib 1cf is damaged or changed. Separation of the filter assembly 10 and the fastening part 20 can be secondarily prevented by the extension rib 1ce.

The engaging portion 1cn may engage the main frame part 1m when the cover frame part 1c is in the closed state, to maintain the closed state of the cover frame part 1c. The engaging portion 1cn may have a latch shape that engages with or disengages from the main frame part 1m as the cover frame part 1c is pressed toward the main frame part 1m, but the present disclosure is not limited thereto. The engaging portion 1cn may be extended downward from the lower surface of the cover frame part 1c when the cover frame part 1c is in the closed state. In addition, the engaging portion 1cn may be positioned forward of the fixing rib 1cf when the cover frame part 1c is in the closed state.

The fastening part 20 may be detachably fastened to the filter mouth of the filter assembly 10 and provide a flow path for the flow of raw water supplied to the filter assembly 10. In addition, the fastening part 20 may be supported on the frame 1f to be disposed forward of the filter assembly 10. The fastening part 20 may be separated from the filter mouth when the filter assembly 10 is moved in a rearward removal direction in the filter support frame 1s. Further, the fastening part 20 may be fastened to the filter mouth when the filter assembly 10 is moved forward in the filter support frame 1s.

The filter assembly 10 can filter raw water and provide purified water. The filter assembly 10 can be accommodated in the filter support frame 1s or removed therefrom. The filter assembly 10 can be moved forward in the filter support frame 1s to be fastened to the fastening part 20, or moved backward to be removed from the fastening part 20. The filter assembly 10 is in close contact with the inclined surface 1cfs and can be moved forward by the inclined surface 1cfs when the cover frame part 1c is pressed downward in the closed state. In addition, the filter assembly 10 can be moved forward by the inclined surface 1cfs when the cover frame part 1c is switched from the open state to the closed state while it is loosely fastened to the fastening part 20. A horizontal diameter of a lower part of the filter assembly 10 may be larger than a horizontal diameter of an upper part of the filter assembly 10. With such a filter assembly 10, the inclined surface 1cfs may be disposed in a region extending directly upward from the outer surface of the lower part of the filter assembly 10 when the cover frame part 1c is in the closed state. A plurality of filter assemblies 10 with different sizes may be provided. The plurality of filter assemblies 10 may include a first filter assembly 10a and a second filter assembly 10b. Either the first filter assembly 10a or the second filter assembly 10b can be accommodated in the filter support frame 1s to provide purified water.

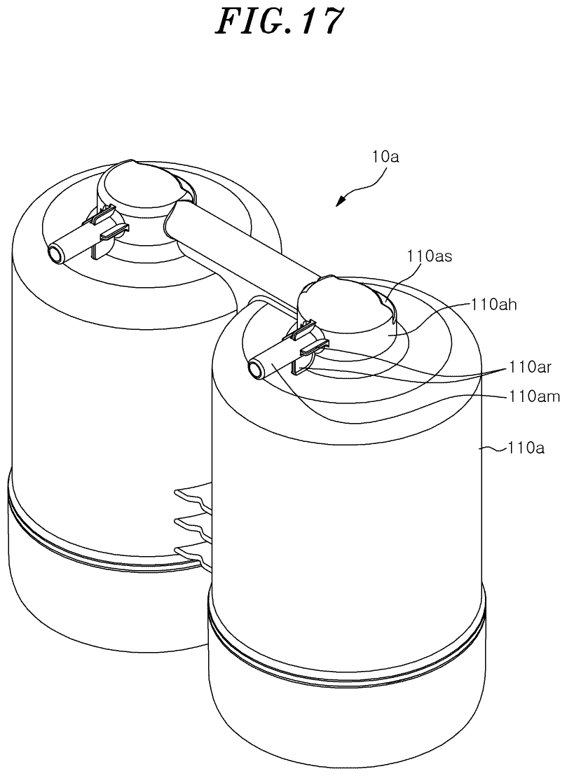

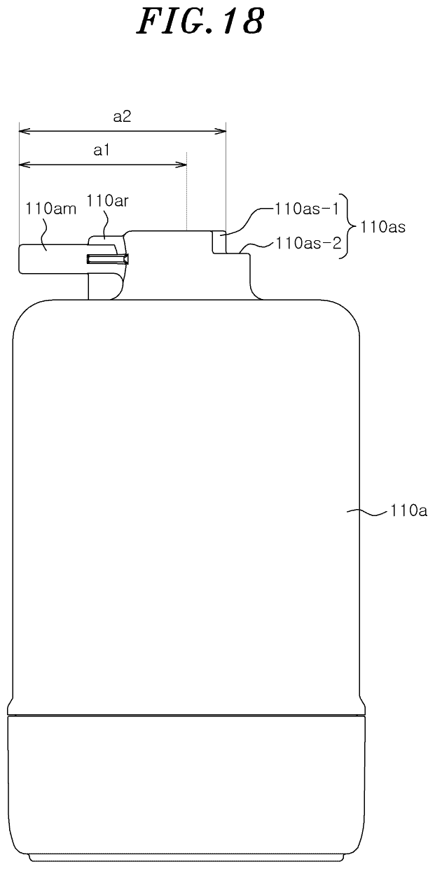

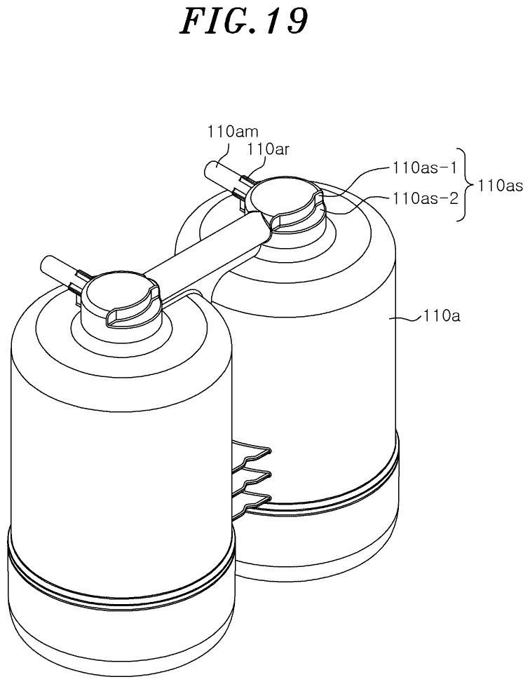

Referring further to FIGS. 17 to 19, the first filter assembly 10a may be capable of filtering a larger amount of purified water than the second filter assembly 10b. The first filter assembly 10a may include a first filter body 110a, a first filter head 110ah, a first filter mouth 110am, and a filter rib 110ar.

The first filter body 110a may provide a space where raw water introduced through the first filter mouth 110am is filtered. The first filter body 110a may be formed in a cylindrical shape, but is not limited thereto. The first filter body 110a may be formed to have a larger width than a second filter body 110b of the second filter assembly 10b, which will be described later. For example, the length of the first filter body 110a in the front-rear direction may be larger than the length of the second filter body 110b in the front-rear direction. The height of the first filter body 110a in the up-down direction may be the same as the height of the first filter body 110a in the up-down direction.

The first filter head 110ah may protrude upward from the top of the first filter body 110a. The first filter head 110ah may have an outer diameter smaller than an outer diameter of the first filter body 110a. In other words, when viewed from above, the edge of the first filter head 110ah may be positioned inwardly of the edge of the first filter body 110a.

In addition, a rear side of the first filter head 110ah may be in contact with the fixing rib 1cf when the cover frame part 1c is in the closed state. When the first filter head 110ah is in close contact with the fixing rib 1cf, the first filter assembly 10a can be blocked from moving rearward. Further, when the cover frame part 1c is in the open state, the close contact of the first filter head 110ah with the fixing rib 1cf can be released. A stepped portion 110as may be formed in the first filter head 110ah.

The stepped portion 110as may be formed on the rear side of the first filter head 110ah. When the cover frame part 1c is in the closed state, the stepped portion 110as may contact the fixing rib 1cf. When the stepped portion 110as is pressed by the fixing rib 1cf, the first filter assembly 10a can be prevented from moving forward or rearward. The stepped portion 110as may include a first step surface 110as-1 and a second step surface 110as-2.

The first step surface 110as-1 may extend downward from a top surface of the first filter head 110ah. In addition, at least a portion of the first step surface 110as-1 may have a shape corresponding to a rear surface of the first filter head 110ah when the first filter body 110a is viewed from above. In other words, at least a portion of the first step surface 110as-1 may have the same radius of curvature as the rear surface of the first filter head 110ah when the first filter body 110a is viewed from above. Further, at least a portion of the first step surface 110as-1 may have the same radius of curvature as a rear surface of a second filter head 110bh, which will be described later.

When the cover frame part 1c is in the closed state, the first step surface 110as-1 may contact the inclined surface 1cfs of the fixing rib 1cf. The first filter assembly 10a can be prevented from moving rearward by the first step surface 110as-1 when the cover frame part 1c is in the closed state. In addition, a horizontal distance from the first step surface 110as-1 to an end of the first filter mouth 110am may be the same as a horizontal distance from the rear surface of the second filter head 110bh to an end of a second filter mouth 110bm, which will be described later. In other words, even if the width of the first filter assembly 10a is formed to be larger than the width of the second filter assembly 10b, the cover frame part 1c can be switched to the closed state by the first step surface 110as-1. In addition, the first step surface 110as-1 and the inclined surface 1cfs may be in line contact when the cover frame part 1c in the closed state.

The second stepped surface 110as-2 may extend rearward from the lower end of the first stepped surface 110as-1 to be connected to the other surface of the first filter head 110ah. In other words, the edge of the second stepped surface 110as-2 may extend along the other surface of the first filter head 110ah.

The first filter mouth 110am may provide a passage for guiding water introduced from the fastening part 20 to the first filter body 110a or for discharging purified water filtered in the first filter body 110a to the fastening part 20. The first filter mouth 110am may extend forward from the front side of the first filter head 110ah. When the first filter assembly 10a moves in the front-rear direction in the filter support frame 1s, the first filter mouth 110am may be fastened to or detached from the fastening part 20. In other words, at least a portion of the first filter mouth 110am may be inserted into the fastening part 20.

In addition, when the first filter mouth 110am is viewed from above, the end of the first filter mouth 110am may be positioned inwardly of the edge of the first filter body 110a. Hereinafter, when the first filter assembly 10a is viewed from the side, a length from the end of the first filter mouth 110am to the center of the first filter head 110ah is referred to as a first length a1, and a length from the end of the first filter mouth 110am to the first step surface 110as-1 is referred to as a second length a2.

The filter rib 110ar may be provided in a plurality and may protrude forward from the front side of the first filter head 110ah. In addition, the plurality of filter ribs 110ar may be arranged to be spaced apart from each other along a circumferential surface of the first filter mouth 110am. One of the plurality of filter ribs 110ar may extend in the up-down direction to be connected to the first filter mouth 110am and the upper portion of the first filter body 110a. The front ends of the plurality of filter ribs 110ar may contact the fastening part 20 when the first filter assembly 10a moves forward in the filter support frame 1s and the first filter mouth 110am is fastened to the fastening part 20. In other words, the first filter mouth 110am may be inserted into the fastening part 20 until the filter ribs 110ar contact the fastening part 20. In addition, when the filter ribs 110ar and the fastening part 20 come into contact, forward movement of the first filter assembly 10a can be blocked with the filter mouth 110am fully fastened to the fastening part 20. By the filter ribs 110ar, it can be confirmed whether the first filter assembly 10a is fully fastened to the fastening part 20.

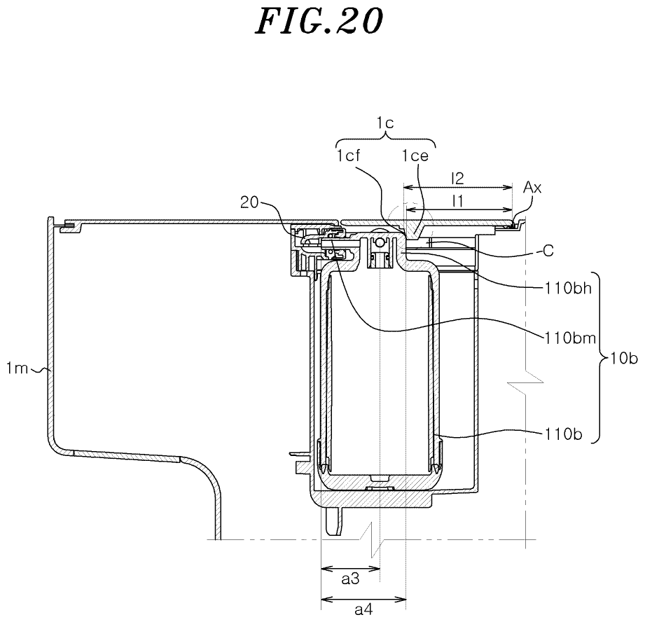

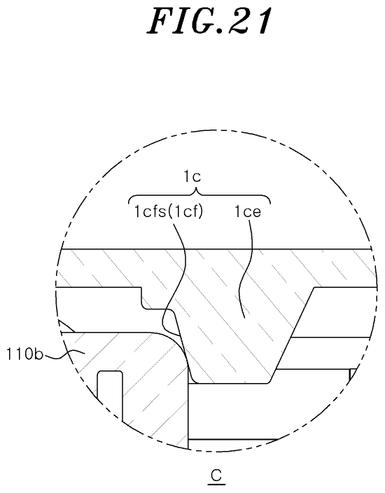

Referring further to FIGS. 20 and 21, the second filter assembly 10b is formed to be smaller than the first filter assembly 10a and can filter raw water. In other words, the amount of raw water filtered by the second filter assembly 10b may be less than the amount filtered by the first filter assembly 10a. Since the first filter assembly 10a is larger than the second filter assembly 10b, a functional filter, such as an anti-scaler, can be accommodated in the first filter assembly 10a. In addition, since the first filter assembly 10a is larger than the second filter assembly 10b, the replacement period for the second filter assembly 10b may be shorter than that of the first filter assembly 10a.

The second filter assembly 10b may be accommodated in the filter support frame 1s instead of the first filter assembly 10a. The second filter assembly 10b may include a second filter body 110b, a second filter head 110bh, and a second filter mouth 110bm.

The second filter body 110b may provide a space for filtering the raw water introduced through the second filter mouth 110bm. The second filter body 110b may be formed in a cylindrical shape, but is not limited thereto. An outer diameter of the second filter body 110b may be smaller than that of the first filter body 110a.

The second filter head 110bh may support the second filter mouth 110bm and extend upward from the top of the second filter body 110b. The outer diameter of the second filter head 110bh may be smaller than that of the second filter body 110b. In other words, the edge of the second filter head 110bh, when viewed from above, may be positioned inwardly of the edge of the second filter body 110b. The outer diameter of the second filter head 110bh may be the same as that of the second filter body 110b. The rear side of the second filter head 110bh may contact the fixing rib 1cf when the cover frame part 1c is in the closed state. When the second filter head 110bh is in close contact with the fixing rib 1cf, the first filter assembly 10a can be blocked from moving rearward. When the cover frame part 1c is in the open state, the close contact of the first filter head 110ah with the fixing rib 1cf can be released.

The second filter mouth 110bm may provide a passage for guiding water introduced from the fastening part 20 to the second filter body 110b or for discharging purified water filtered in the second filter body 110b to the fastening part 20. In other words, at least a portion of the second filter mouth 110bm may be inserted into the fastening part 20.

When the second filter assembly 10b is viewed from the side, a third length a3, which is the length from the end of the second filter mouth 110bm to the center of the second filter head 110bh, may be smaller than the first length a1. In addition, when the second filter assembly 10b is viewed from the side, a fourth length a4, which is the length from the end of the second filter mouth 110bm to the rear surface of the second filter head 110bh, may be the same as the second length a2.

The discharge part 1d may discharge purified water filtered by the filter assembly 10 to the outside to provide the purified water to the user. The discharge part 1d may be supported at the front side of the frame 1f.

Hereinafter, the operation and effects of the filter assembly 10 according to the first embodiment of the present disclosure will be described.

In the filter assembly 10 according to the first embodiment of the present disclosure, by placing the supporter 400 in the upper side of the housing 100, the water treatment member 300 can be accommodated in the housing 100 through the supporter 400. The water treatment member 300 can be conveniently and easily replaced in the filter assembly 10 through the supporter 400.

In addition, the first cap 410 includes the first body 411, the first upper cap 412, and the first lower cap 413, wherein the first body 411, the first upper cap 412, and the first lower cap 413 are formed to have the same thickness, inner diameter, and outer diameter, so that it is possible to prevent the diameter reduction of the filter and the membrane area reduction, which occur when the thickness, inner diameter, and outer diameter differ from each other.

Moreover, the second upper cap 422 can be provided in the form of a mesh. The second upper cap 422 provided in the form of a mesh can prevent the water treatment particles discharged from the water treatment pouch 310 from escaping from the second cap 420 and being discharged through the openings 421-1, even when the water treatment particles are discharged from the water treatment pouch 310.

Further, multiple water treatment particles can be accommodated in the pouch space of the flexible water treatment pouch 310, which makes weight adjustment and management of the multiple water treatment particles convenient. Furthermore, by varying the color of the water treatment pouch 310 according to the type of water treatment particles, users can easily distinguish the type of water treatment particles based on the color of the water treatment pouch 310.

In addition, since the first upper cap 412 and the first lower cap 413 of the filter assembly 10 according to the first embodiment of the present disclosure can be spaced apart from each other by a distance greater than the length of the first body 411, the filter member 200 may not be limited to being increased in size by only one of the first upper cap 412, the first lower cap 413, and the first body 411.

In other words, the first upper cap 412, the first lower cap 413, and the first body 411 are spaced apart, so that a large space for accommodating the filter member 200 can be formed, which increases the size of the filter member 200 and enhances the filtration performance. For example, the filter member 200 can be formed to be large such that its peripheral surface contacts the filter housing 200.

Moreover, even if the internal diameter of the filter support frame 1s of the water purifier 1 is narrow or the increase in the outer diameter of the filter housing 100 is limited, the size of the filter member 200 can be increased, which improves the filtration performance.

Hereinafter, the operation and effects of the water purifier 1 according to the second embodiment of the present disclosure will be described.

In the first filter assembly 10a of the water purifier 1 according to the second embodiment of the present disclosure, the stepped portion 1cfs that can contact the fixing rib 1cf of the water purifier 1 is formed, so that the first filter assembly 10a can be prevented from moving rearward due to water pressure in the water purifier 1.

In addition, any one of the plurality of filter assemblies 10 of different sizes is formed with the stepped portion 110as, so that it can be exchanged with the other one of the filter assemblies 10 installed inside the water purifier 1, which improves compatibility. In other words, the first filter assembly 10a can be exchanged with the second filter assembly 10b accommodated inside the frame 1f by the stepped portion 110as.

The examples of the present disclosure have been described above as specific embodiments, but these are only examples, and the present disclosure is not limited thereto, and should be construed as having the widest scope according to the technical spirit disclosed in the present specification. A person skilled in the art may combine/substitute the disclosed embodiments to implement a pattern of a shape that is not disclosed, but it also does not depart from the scope of the present disclosure. In addition, those skilled in the art can easily change or modify the disclosed embodiments based on the present specification, and it is clear that such changes or modifications also belong to the scope of the present disclosure.

What is claimed is:

1. A filter assembly comprising:
a housing;
a filter member, disposed inside the housing, for filtering raw water to provide purified water;
a water treatment member, disposed inside the housing, for treating the purified water; and
a supporter disposed inside the housing to support the filter member and the water treatment member,
wherein the supporter includes:
a first cap supporting an exterior of the filter member; and
a second cap supporting an interior of the filter member and providing an accommodation space in which the water treatment member is accommodated, and
wherein the second cap includes:
a second body having an opening, formed in an upper portion thereof, through which the water treatment member is taken in and out, and a second body hole, formed in a side wall thereof, through which the purified water passes; and
a second upper cap arranged to be fixed to the opening and having a second cap hole through which the purified water passes.

2. The filter assembly of claim 1, wherein the first cap includes:
a first body supporting an outer diameter surface of the filter member, and having a first body hole through which the raw water passes;
a first upper cap supporting an upper end portion of the filter member and having a first cap hole corresponding to the second cap hole; and
a first lower cap supporting a lower end portion of the filter member.

3. The filter assembly of claim 2, wherein the first body, the first upper cap, and the first lower cap are formed to have the same thickness and outer diameter.

4. The filter assembly of claim 2, wherein the second upper cap is spaced apart from an upper end of the second body to form a space between the second cap hole and the first cap hole.

5. The filter assembly of claim 1, wherein the water treatment member is formed with an outer diameter that is at least larger than an inner diameter of the second body hole and an inner diameter of the second cap hole.

6. The filter assembly of claim 1, wherein the second upper cap includes:
a second cap portion having a through-hole in a center thereof; and
a second mesh portion fixed to the second cap portion to be located in the through-hole, the second cap hole being provided in the form of a mesh in the second mesh portion.

7. The filter assembly of claim 1, wherein the second upper cap is fixed to the second body through ultrasonic fusion.

8. The filter assembly of claim 1, wherein the water treatment member includes:
a water treatment pouch that provides a pouch space therein and is made of a flexible material; and
a plurality of water treatment particles accommodated in the pouch space.

9. The filter assembly of claim 1, wherein the first cap includes:
a first upper cap covering one surface of the filter member;
a first lower cap covering the other surface of the filter member; and
a first body provided between the one surface and the other surface of the filter member to cover a peripheral surface of the filter member,
wherein the first upper cap and the first lower cap are arranged to be spaced apart from each other by a distance equal to or greater than a length of the first body,
wherein an end of the first upper cap is disposed to face one end of the first body,
wherein an end of the first lower cap is disposed to face the other end of the first body, and
wherein the first body has a shape spaced apart from at least one of the first upper cap and the first lower cap.

10. The filter assembly of claim 9, wherein the first upper cap includes:
a first end cover part in contact with the one surface of the filter member; and
a first extension part extending from an edge of the first end cover part toward the first lower cap and covering a portion of the peripheral surface of the filter member, and
wherein the first lower cap includes:
a second end cover part in contact with the other surface of the filter member; and
a second extension portion extending from an edge of the second end cover portion toward the first upper cap and covering another portion of the peripheral surface of the filter member.

11. The filter assembly of claim 9, wherein at least one of an inner diameter of the first upper cap and an inner diameter of the first lower cap is smaller than an outer diameter of the first body.

12. The filter assembly of claim 9, wherein the first upper cap is disposed to face one end of the first body but not overlap the first body, and
the first lower cap is disposed to face the other end of the first body but not overlap the first body.

13. The filter assembly of claim 1, further comprising:
a filter head protruding upward from an upper portion of the housing; and
a filter mouth extending in one direction from one side of the filter head,
wherein a stepped portion is formed on the other side of the filter head, and
wherein the stepped portion includes:
a first step surface extending downward from a top surface of the filter head; and
a second step surface extending in the other direction from the first step surface and connected to the other side of the filter head.

14. The filter assembly of claim 13, wherein at least a portion of the first step surface has a shape corresponding to a surface of the other side of the filter head when the housing is viewed from above.

15. The filter assembly of claim 14, wherein at least a portion of the first step surface has the same radius of curvature as the surface of the other side of the filter head when the housing is viewed from above.

16. The filter assembly of claim 13, wherein a front end of the filter mouth is disposed inside an edge of the housing when viewing the housing from directly above.

17. The filter assembly of claim 13, further comprising:
a plurality of filter ribs that protrude forward from a front side of the filter head and are spaced apart from each other along a peripheral surface of the filter mouth,
wherein one of the plurality of filter ribs extends in an up-down direction to be connected to the filter mouth and the upper portion of the housing.

18. A filter assembly comprising:
a housing;
a filter member for filtering raw water to provide purified water;
a water treatment member for treating the purified water; and
a supporter disposed inside the housing to support the filter member and the water treatment member,
wherein the supporter includes:
a first cap supporting an exterior of the filter member; and
a second cap supporting an interior of the filter member and providing an accommodation space in which the water treatment member is accommodated, and
wherein the water treatment member includes:
a water treatment pouch that provides a pouch space therein and is made of a flexible material; and
a plurality of water treatment particles accommodated in the pouch space.

19. The filter assembly of claim 18, wherein the water treatment pouch is provided in different colors depending on types of water treatment particles so that the types of water treatment particles are distinguished by color.

20. A water purifier comprising:
the filter assembly of claim 1; and
a frame for accommodating the filter assembly,
wherein the frame includes:
a filter support frame that provides an accommodation space for accommodating the filter assembly; and
a cover frame part configured to be in an open state that opens an upper end of the accommodation space of the filter support frame or in a closed state that closes the upper end of the accommodation space,
wherein the cover frame part includes a fixing rib extending downward from a lower surface of the cover frame part to fix the filter assembly accommodated in the accommodation space when the cover frame part is in the closed state, and
wherein the fixing rib contacts a stepped portion of the filter assembly when the cover frame part is in the closed state.
